(19) United States
(12) Patent Application Publication
(10) Pub. No.: US 2015/0295521 A1
(43) Pub. Date: Oct. 15, 2015

(54) ELECTROSTATIC CHUCK AND POWER SUPPLY SYSTEM

(71) Applicant: CREATIVE TECHNOLOGY CORPORATION, Tokyo (JP)

(72) Inventors: Yoshiaki Tatsumi, Kawasaki-shi (JP); Toshifumi Sugawara, Kawasaki-shi (JP)

(73) Assignee: CREATIVE TECHNOLOGY CORPORATION, Tokyo (JP)

(21) Appl. No.: 14/441,957

(22) PCT Filed: Sep. 24, 2013
(86) PCT No.: PCT/JP2013/075602

§ 371 Date: May 11, 2015

(30) Foreign Application Priority Data
Nov. 22, 2012 (JP) 2012-256154

(51) Int. Cl. H02N 13/00

(52) U.S. Cl. CPC H02N 13/00

(57) ABSTRACT

In an electrostatic chuck and a power supply system, high-voltage drive is performed without generating electrical discharge even in a vacuum atmosphere, and a structure of the power supply system for the electrostatic chuck is simplified. This power supply system includes: an electrostatic chuck (2) having a booster circuit (3); and an electric contact mechanism (4). Terminals (31a, 32a) of the booster circuit (3) are exposed to the outside. The terminals (31b, 32b) are connected to an attraction electrode (23). The electric contact mechanism (4) is configured from rails (41, 42), and flexible contacts (43, 44) in contact with the rails. The rails (41, 42) are connected to an external power supply (40), and the flexible contacts (43, 44) are provided on conductive plates (45, 46) of the electrostatic chuck (2). The conductive plates (45, 46) are connected to the terminals (31a, 32a) of the booster circuit (3).

### TECHNICAL FIELD

The present invention relates to an electrostatic chuck and a power supply system for holding a workpiece plate body such as a glass substrate.

### BACKGROUND ART

As shown in FIG. 8, an electrostatic chuck 100 is usually fixed to the inside bottom of a vacuum chamber 200 of a processing apparatus. A driving power-supply voltage or electrical signal is fed to the electrostatic chuck 100 from a power supply 210 installed outside the vacuum chamber 200, and a workpiece plate body W is held by the electrostatic chuck 100 (e.g. see PTL 1).

However, such a system in which the electrostatic chuck 100 is fixed to the apparatus 200 cannot move the workpiece plate body W to a predetermined place in the apparatus 200 or invert the workpiece plate body W in the apparatus 200, and is therefore inferior in adaptability to processing operations.

To handle this, a system has recently been devised in which the electrostatic chuck 100 is movably installed inside the vacuum chamber 200 of the processing apparatus.

As shown in FIG. 9, the electrostatic chuck 100 is slidably placed on a stage 150. This allows the electrostatic chuck 100 to be conveyed to a predetermined place in the vacuum chamber 200 while holding a workpiece plate body W, so that the workpiece plate body W is placed in the predetermined place.

Usually, in such a system, the power supply 210 is installed outside the vacuum chamber 200, and the power supply 210 and power supply pins 131 sticking out of a holding electrode 130 are connected to each other through voltage cables 220.

Incidentally, from the viewpoint of upsizing displays and shortening working hours, there has recently been a need to hold and convey a large-size and heavy-weight workpiece plate body W such as a glass substrate with the electrostatic chuck 100.

In order to hold such a large-size and heavy-weight workpiece plate body W, it is necessary to enhance the holding power of the electrostatic chuck 100 by raising the voltage that is to be supplied to the holding electrode 130 of the electrostatic chuck 100. Especially in the case of a chuck required to hold a heavy workpiece plate body W on the lower side of the chuck, like in the case of an electrostatic chuck 100 for use in a deposition apparatus, very high holding power is required.

However, since there is a vacuum atmosphere in the vacuum chamber 200, there is a high risk that discharge may occur between the voltage cables 220.

For this reason, high-voltage cables are used as the voltage cables 220, and in consideration of a region where discharge easily occurs according to Paschen's law, discharge in a cable portion in the apparatus 200 is prevented. This is achieved by sealing, with silicone or epoxy-rubber-based resin, a place where a conductive portion tends to be exposed. Specifically, connections between internal cable portions 221 of the voltage cables 220 and the power supply pins 131 are sealed with sealants 231, and connections between the internal cables portions 221 of the voltage cables 220 and external cable portions 222 are sealed with sealants 232.

### CITATION LIST

### Patent Literature

PTL 1: Japanese Patent Application Laid-Open No. 2011-238934 A

### SUMMARY OF INVENTION

### Technical Problem

However, the conventional technology described above has the following problems:

That is, long-standing repetition of movement of the electrostatic chuck 100 puts a load on the connections between the internal cables portions 221 and the power supply pins 131 and the connections between the internal cables portions 221 and the external cable portions 222 and may therefore cause the sealants 231 and 232 to deteriorate. As a result of this, these connections may be exposed to cause discharge.

Furthermore, since it is necessary to install the long cable portions 221 in the vacuum chamber 200, provide pipes for the cables, and provide the sealants 231 and 232, the structure of a power supply system configured to supply electricity to the electrostatic chuck is complicated.

The present invention has been made in order to solve the problems described above, and it is an object of the present invention to provide an electrostatic chuck and a power supply system that make high-voltage driving possible without causing discharge to occur even in a vacuum atmosphere and that simplify the structure of a power supply system configured to supply electricity to an electrostatic chuck.

### Solution to Problems

In order to solve the problems described above, an electrostatic chuck according to claim 1 of the present invention includes: an electrostatic holding layer including a dielectric and a holding electrode, the dielectric layer having a surface serving as a holding surface on which a workpiece plate body is held, the holding electrode being placed within the dielectric; a base member of which the electrostatic holding layer is placed on the upper surface; and a booster circuit including low-voltage input terminals through which a low voltage from an external power supply is inputted and high-voltage output terminals through which a high voltage obtained by raising the low voltage is supplied to the holding electrode, the booster circuit being mounted in the base member, electrical connections between ends of wires and the high-voltage output terminals being contained in the base member so as to be in an unexposed state, the wires being drawn out in an unexposed state from the holding electrode through the dielectric and the base member.

According to this configuration, when the electrostatic chuck is placed in a vacuum chamber and a low voltage from the external power supply, which is installed outside the vacuum chamber, is sent to the electrostatic chuck, the low voltage is inputted to the booster circuit through the low-voltage input terminals. Then, the low voltage is raised to a high voltage by the booster circuit, and the high voltage is outputted from the high-voltage output terminals to the holding electrode, whereby an electrostatic force is generated on the workpiece plate body and an electrostatic holding layer surface. The electrostatic force causes the workpiece plate body to be held on the electrostatic holding layer surface. In this state, the workpiece plate body can be conveyed together with the electrostatic chuck in the vacuum chamber.

Incidentally, the low voltage from the external power supply is inputted to the low-voltage input terminals of the booster circuit through cables leading from the external power supply into the vacuum chamber. Therefore, since the low voltage is supplied between each of the cables and the booster circuit, no discharge occurs on the cables per se. Further, no discharge occurs even in a case where connections between the cables and the low-voltage input terminals are exposed.

However, since the high voltage is supplied between each of the high-voltage output terminals of the booster circuit and the holding electrode, there is a risk that discharge may occur on wires per se between the booster circuit and the holding electrode and at connections between the high-voltage output terminals and the ends of the wires.

In the electrostatic chuck according to claim 1 of the present invention, however, the wires extend from the holding electrode through the dielectric and the base member, and the electrical connections between the ends of the wires and the high-voltage output terminals are contained in the base member so as to be in an unexposed state. Therefore, even if a high voltage is supplied between each of the high-voltage output terminals of the booster circuit and the holding electrode, there is no risk that discharge may occur on the wires per se or at the connections between the high-voltage output terminals and the ends of the wires.

In claim 1 of the present invention, an electrostatic chuck according to claim 2 of the present invention is configured such that the booster circuit inputs a voltage in the range of 5 volts to 100 volts through the low-voltage input terminals and outputs a voltage in the range of 300 volts to 10000 volts through the high-voltage output terminals.

A power supply system according to claim 3 of the present invention includes: an electrostatic chuck according to claim 1 or claim 2, the electrostatic chuck being conveyed by a conveying mechanism installed inside a vacuum chamber; and an electrical contact mechanism including fixed electrodes and movable electrodes, the fixed electrodes being fixed in the vacuum chamber and connected to the external power supply, the movable electrodes being configured to move together with the electrostatic chuck and connected to the low-voltage input terminals of the booster circuit, respectively, contact between the fixed electrodes and the movable electrodes causing the low voltage from the external power supply to be inputted to the low-voltage input terminals of the booster circuit.

According to this configuration, while the electrostatic chuck is being conveyed by the conveying mechanism in the vacuum chamber, the low voltage from the external power supply installed outside the vacuum chamber is supplied to the fixed electrodes fixed in the vacuum chamber. Since, at this time, the movable electrodes configured to move together with the electrostatic chuck are in contact with the fixed electrodes, the low voltage from the external power supply is inputted to the low-voltage input terminals of the booster circuit through the fixed electrodes and the movable electrodes. Then, the booster circuit raises the low voltage to a high voltage that is supplied to the holding electrode through the high-voltage output terminals and the wires.

That is, during conveyance of the electrostatic chuck, the low voltage from the external power supply continues to be supplied to the low-voltage input terminals of the booster circuit through the electrical contact mechanism.

In a case where electricity is fed to the electrostatic chuck that is conveyed, it is in general necessary to make cables from the external power supply to the electrostatic chuck long.

However, since the power supply system according to claim 3 of the present invention is configured such that the cables from the external power supply are connected to the fixed electrodes fixed in the vacuum chamber, respectively, the cables need only have such lengths as to reach the fixed electrodes, respectively. This can make the cables very short. Further, since the low voltage is supplied to the cables, it is not necessary to seal the connections between the cables and the fixed electrodes.

In claim 3 of the present invention, a power supply system according to claim 4 of the present invention is configured such that: the fixed electrodes of the electrical contact mechanism are formed by conductive rails placed parallel to a direction of conveyance in close proximity to the electrostatic chuck; and the movable electrodes of the electrical contact mechanism are formed by conductive flexible contacts attached to the electrostatic chuck in contact with the rails, respectively.

According to this configuration, since the conductive flexible contacts attached to the electrostatic chuck are in contact with the rails, respectively, the low voltage from the external power supply is inputted to the low-voltage input terminals of the booster circuit through the rails and the conductive flexible contacts. Then, the booster circuit raises the low voltage to a high voltage that is supplied to the holding electrode through the high-voltage output terminals and the wires. For this reason, the cables from the external power supply need only have such lengths as to reach the rails, respectively, nor do the cables need to be sealed.

In claim 3 of the present invention, a power supply system according to claim 5 of the present invention is configured such that: the conveying mechanism includes a plurality of conductive rollers and a pair of lanes, the plurality of conductive rollers being arranged along the direction of conveyance, the pair of lanes being set parallel to each other and configured to rotatably support these rollers; and the fixed electrodes of the electrical contact mechanism are formed by the plurality of conductive rollers; and the movable electrodes of the electrical contact mechanism are formed by electrode plates configured to move together with the electrostatic chuck while continuing to be in contact with the rollers.

According to this configuration, since the electrode plates configured to move together with the electrostatic chuck are in contact with the plurality of conductive rollers, the low voltage from the external power supply is inputted to the low-voltage input terminals of the booster circuit through the rollers and the electrode plates. Then, the booster circuit raises the low voltage to a high voltage that is supplied to the holding electrode through the high-voltage output terminals and the wires. For this reason, the cables from the external power supply need only have such lengths as to reach the rollers, respectively, nor do the cables need to be sealed.

A power supply system according to claim 6 of the present invention includes: an electrostatic chuck according to claim 1 or claim 2, the electrostatic chuck being conveyed by a conveying mechanism installed inside a vacuum chamber; and an electromagnetic induction apparatus including a fixed coil and a movable coil, the fixed coil being fixed in the vacuum chamber and connected to the external power supply, the movable coil being configured to move together with the electrostatic chuck without being in contact with the fixed coil and connected to the low-voltage input terminals of the booster circuit, electromagnetic induction from the fixed coil to the movable coil causing the low voltage from the external power supply to be inputted to the low-voltage input terminals of the booster circuit.

According to this configuration, while the electrostatic chuck is being conveyed by the conveying mechanism in the vacuum chamber, the low voltage from the external power supply installed outside the vacuum chamber is supplied to the fixed coil, fixed in the vacuum chamber, of the electromagnetic induction apparatus. With this, electromagnetic induction from the fixed coil to the movable coil causes a low voltage to be generated in the movable coil and inputted to the low-voltage input terminals of the booster circuit. Then, the booster circuit raises the low voltage to a high voltage that is supplied to the holding electrode through the high-voltage output terminals and the wires.

That is, during conveyance of the electrostatic chuck, the low voltage from the external power supply continues to be supplied to the low-voltage input terminals of the booster circuit through the electrically contactless electromagnetic induction apparatus.

In claim 6 of the present invention, a power supply system according to claim 7 of the present invention is configured such that: the fixed coil of the electromagnetic induction apparatus is fixed in the vacuum chamber; and the movable coil of the electromagnetic induction apparatus is attached to the electrostatic chuck.

A power supply system according to claim 8 of the present invention includes: an electrostatic chuck according to claim 1 or claim 2, the electrostatic chuck being conveyed by a conveying mechanism installed inside a vacuum chamber; a transparent top plate through which rays of light from an external light source is introduced into the vacuum chamber, the transparent top plate being provided on at least an upper surface of the vacuum chamber; and a photovoltaic apparatus configured to convert, into low-voltage electricity, the rays of light introduced into the vacuum chamber through the transparent top plate and input the low-voltage electricity to the low-voltage input terminals of the booster circuit of the electrostatic chuck.

According to this configuration, while the electrostatic chuck is being conveyed by the conveying mechanism in the vacuum chamber, rays of light from the external light source are introduced into the vacuum chamber through the transparent top plate, and these rays of light are converted into low-voltage electricity by the photovoltaic apparatus. Then, the low voltage thus obtained is inputted to the low-voltage input terminals of the booster circuit, which then raises the low voltage to a high voltage that is supplied to the holding electrode through the high-voltage output terminals and the wires.

That is, during conveyance of the electrostatic chuck, the electrostatic chuck continues to be driven by the rays of light from the external light source.

In claim 8 of the present invention, a power supply system according to claim 9 of the present invention is configured such that: the photovoltaic apparatus is attached to the electrostatic chuck.

### Advantageous Effects of Invention

As described above in detail, the electrostatic chuck according to claim 1 or claim 2 of the present invention is configured such that in the vacuum chamber, only the low-voltage supply portions extending from the external power supply to the booster circuit are in an exposed state and the high-voltage supply portions such as the wires between the booster circuit and the holding electrode per se and the connections between the high-voltage output terminals and the ends of the wires are in an unexposed state. This configuration suppresses an electrical breaking mode (arcing) in the high-voltage supply portions, thus preventing the insulating portion from being broken down by driving. That is, the present invention brings about an advantageous effect of making high-voltage driving possible without causing discharge to occur even in a vacuum atmosphere.

Further, since the power supply system according to any one of claim 3 to claim 5 of the present invention is configured such that the cables from the external power supply are connected to the fixed electrodes fixed in the vacuum chamber, respectively, the cables need only have such lengths as to reach the fixed electrodes, respectively. This can make the cables very short. Further, since the low voltage is supplied to the cables, it is not necessary to seal the connections between the cables and the fixed electrodes. Therefore, the number of cables, pipes for the cables, sealing mechanism, or the like that are disadvantageous in a vacuum atmosphere can be reduced. This in turn brings about an advantageous effect of simplifying the structure of a power supply system configured to supply electricity to an electrostatic chuck.

Further, since the power supply system according to claim 6 or claim 7 of the present invention is configured such that during conveyance of the electrostatic chuck, the low voltage from the external power supply continues to be supplied to the low-voltage input terminals of the booster circuit through the electrically contactless electromagnetic induction apparatus. This brings about an advantageous effect of further enhancing the effect of preventing discharge in a vacuum atmosphere.

In particular, since the power supply system according to claim 8 or claim 9 of the present invention is configured such that during conveyance of the electrostatic chuck, the electrostatic chuck continues to be driven by the rays of light from the external light source. This makes it possible to completely eliminate the need for cables, pipes, and the like extending from the external power supply to the electrostatic chuck. This in turn brings about an advantageous effect of further simplifying the structure of a power supply system.

### BRIEF DESCRIPTION OF DRAWINGS

FIG. 1 is a schematic cross-sectional view showing an electrostatic chuck and a power supply system according to a first embodiment of the present invention.

FIG. 2 is a cross-sectional view showing the electrostatic chuck.

FIG. 3 is a schematic plan view showing the power supply system.

FIG. 4 is a cross-sectional view showing a power supply system according to a second embodiment of the present invention.

FIG. 5 is a schematic plan view showing the power supply system of the second embodiment.

FIG. 6 is a schematic plan view showing a power supply system according to a third embodiment of the present invention.

FIG. 7 is a cross-sectional view showing a power supply system according to a fourth embodiment of the present invention.

FIG. 8 is a cross-sectional view showing an example of a conventional technology.

FIG. 9 is a cross-sectional view showing another example of a conventional technology.

### DESCRIPTION OF EMBODIMENTS

Best modes of the present invention are described below with reference to the drawings.

### First Embodiment

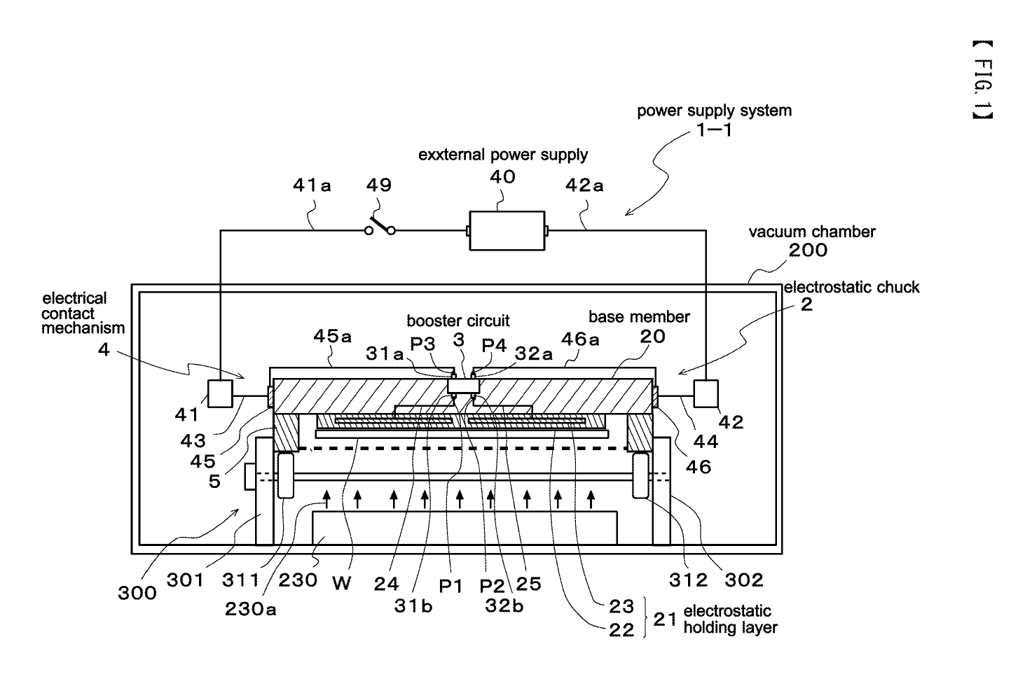

FIG. 1 is a schematic cross-sectional view showing an electrostatic chuck and a power supply system according to a first embodiment of the present invention.

As shown in FIG. 1, a power supply system 1-1 illustrated in the present embodiment is a system configured to supply electricity from an external power supply to an electrostatic chuck 2 installed inside a vacuum chamber 200 of a deposition apparatus. The power supply system 1-1 includes the electrostatic chuck 2 and an electrical contact mechanism 4. The electrostatic chuck 2 is conveyed by a conveying mechanism 300.

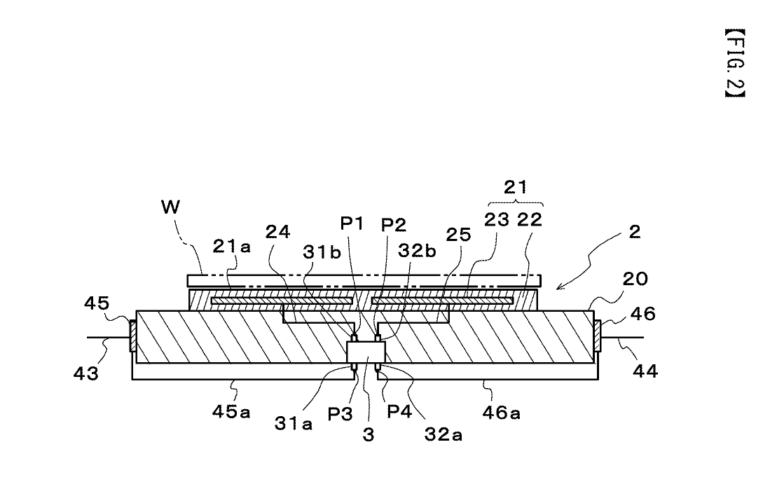

FIG. 2 is a cross-sectional view showing the electrostatic chuck 2.

As shown in FIG. 2, the electrostatic chuck 2 includes a base member 20, an electrostatic holding layer 21, and a booster circuit 3.

The base member 20 is made of aluminum, SUS, iron, copper, titanium, a ceramic (including ALN, SiC, Al₂O₃, SiN, zirconium, BN, TiC, and TiN), or the like. The electrostatic holding layer 21 is attached to a surface of the base member 20.

The electrostatic holding layer 21 includes a dielectric 22 and a holding electrode 23. The electrostatic holding layer 21 has a surface 21a serving as a holding surface on which a workpiece plate body W such as a glass substrate is held.

The dielectric 22 is formed by a polyimide film or a ceramic.

The holding electrode 23 is made of a conducting substance (in foil or paste form) composed mostly of or mixed with carbon ink, Cu, SUS, iron, nickel, silver, platinum, or the like. The holding electrode 23 is electrically connected to the booster circuit 3 through wires 24 and 25.

The booster circuit 3 is a device configured to receive a low voltage through low-voltage input terminals 31a and 32a, raise the low voltage to a high voltage, and output the high voltage through high-voltage output terminals 31b and 32b. An example of the booster circuit 3 is a DC-DC converter, an AC-DC converter, or an AC-AC converter.

The booster circuit 3 is mounted in such a state as to be embedded in the base member 20.

Specifically, the low-voltage input terminals 31a and 32a are exposed on the outside, and the high-voltage output terminals 31b and 32b are contained in the base member 20. Moreover, the high-voltage output terminals 31b and 32b are connected to ends of the wires 24 and 25 drawn out from the holding electrode 23 through the dielectric 22 and the base member 20, respectively, and these electrical connections P1 and P2 are placed in an unexposed state.

As shown in FIG. 1, the electrostatic chuck 2 including the booster circuit 3 thus configured is loaded on the conveying mechanism 300 installed inside the vacuum chamber 200.

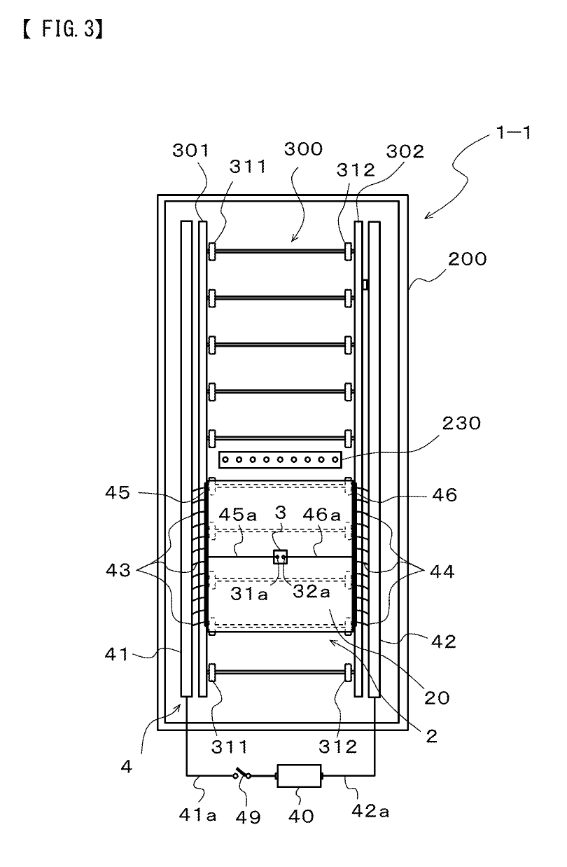

FIG. 3 is a schematic plan view showing the power supply system 1-1.

As shown in FIGS. 1 and 3, the conveying mechanism 300 includes: a pair of lanes 301 and 302; plural pairs of rollers 311 and 312 rotatably supported by these lanes 301 and 302; and a driving mechanism (not illustrated) configured to drive the rollers 311 and 312 to rotate.

In the deposition apparatus, it is necessary to spray a deposition material 230a from a deposition source 230 on the floor of the vacuum chamber 200 onto a workpiece plate body W located above the deposition source 230 and thereby deposit the deposition material 230a on the workpiece plate body W. For this purpose, as shown in FIG. 1, the electrostatic chuck 2 is loaded on the rollers 311 and 312 of the conveying mechanism 300 in such a state as to face downward.

Specifically, a mask 5 is loaded on the rollers 311 and 312, and the electrostatic chuck 2 holding the workpiece plate body W is assembled to the mask 5 with the workpiece plate body W facing downward. This allows the deposition material 230a sprayed from the deposition source 230 located below the workpiece plate body W to be deposited on the surface of the workpiece plate body W into a shape that corresponds to a pattern of the mask 5.

The electrical contact mechanism 4 is a mechanism configured to allow a low voltage from an external power supply 40 to be inputted to the low-voltage input terminals 31a and 32a of the booster circuit 3.

The electrical contact mechanism 4 includes conductive rails 41 and 42 and conductive flexible contacts 43 and 44. The conductive rails 41 and 42 serve as fixed electrodes. The conductive flexible contacts 43 and 44 serve as movable electrodes.

Specifically, the rails 41 and 42 are placed parallel to a direction of conveyance (i.e. a direction from the front side to the back side of the paper on which FIG. 1 is drawn or a direction from the upper side to the lower side of FIG. 3) in close proximity to the electrostatic chuck 2, and are fixed in the vacuum chamber 200. Moreover, the rail 41 is connected to a first terminal of the external power supply 40 through a cable 41a, and the rail 42 is connected to a second terminal of the external power supply 40 through a cable 42a.

Further, as shown in FIG. 3, a conductive plate 45 is attached to a left side surface of the base member 20 of the electrostatic chuck 2 via an insulator film (not illustrated), and the plurality of flexible contacts 43 are implanted in the conductive plate 45. Moreover, a conductive plate 46 is attached to a right side surface of the base member 20 via an insulator film (not illustrated), and the plurality of flexible contacts 44 are implanted in the conductive plate 46.

As shown in FIG. 1, the flexible contacts 43 and 44 have their leading ends pressed against the rails 41 and 42, respectively, and the flexible contacts 43 and 44 move in the direction of conveyance together with the electrostatic chuck 2 while continuing to be in contact with the rails 41 and 42, respectively.

Further, the conductive plate 45, in which the flexible contacts 43 are implanted, is connected to the low-voltage input terminal 31a of the booster circuit 3 through a cable 45a, and the conductive plate 46, in which the flexible contacts 44 are implanted, is connected to the low-voltage input terminal 32a of the booster circuit 3 through a cable 46a.

As described above, the external power supply 40 is connected to the low-voltage input terminals 31a and 32a of the booster circuit 3 through the contact between the rails 41 and 42 and the flexible contacts 43 and 44, respectively, and the high-voltage output terminals 31b and 32b of the booster circuit 3 are connected to the holding electrode 23 through the wires 24 and 25, respectively.

This allows a low voltage from the external power supply 40 to be inputted to the booster circuit 3 through the electrical contact mechanism 4, and allows a high voltage from the booster circuit 3 to be supplied to the holding electrode 23 through the wires 24 and 25.

The low voltage from the external power supply 40 is settable to a voltage in the range of 5 volts to 100 volts, and the high voltage from the booster circuit 3 is settable to a voltage in the range of 300 volts to 10000 volts.

In the present embodiment, a voltage of +24 volts is applied to the low-voltage input terminal 31a of the booster circuit 3, and the low-voltage input terminal 32a is grounded. Moreover, the settings are configured such that voltages of +2000 volts and −2000 volts are outputted from the high-voltage output terminals 31b and 32b, respectively, so that a high voltage of 4000 volts is applied to the holding electrode 23.

Functions and effects of the electrostatic chuck and the power supply system of the present embodiment are described below.

In FIG. 1, closing a switch 49 causes a low voltage of +24 volts from the external power supply 40 to be inputted to the low-voltage input terminals 31a and 32a of the booster circuit 3 through the electrical contact mechanism 4 and the cables 45a and 46a, respectively. Then, high voltages of +2000 volts and −2000 volts are outputted from the high-voltage output terminals 31b and 32b of the booster circuit 3, respectively, so that a high voltage of 4000 volts is applied to the holding electrode 23 through the wires 24 and 25.

This generates a strong electrostatic force on the workpiece plate body W and an electrostatic holding layer surface 21a, and the strong electrostatic force causes the workpiece plate body W to be held on the electrostatic holding layer surface 21a.

Incidentally, since the low voltage of +24 volts from the external power supply 40 is supplied between each of the cables 41a and 42a and the booster circuit 3, no discharge occurs on the cables 41a and 42a per se. Further, no discharge occurs even in a case where a connection P3 between the cable 41a and the low-voltage input terminal 31a and a connection P4 between the cable 42a and the low-voltage input terminal 32a are exposed.

However, since a high voltage of 4000 volts is supplied between each of the high-voltage output terminals 31b and 32b of the booster circuit 3 and the holding electrode 23, there is a risk that discharge may occur on the wires 24 and 25 per se between the booster circuit 3 and the holding electrode 23, at the connection P1 between the high-voltage output terminal 31b and the end of the wire 24, and at the connection P2 between the high-voltage output terminal 32b and the end of the wire 25.

In the electrostatic chuck 2 of the present embodiment, however, the wires 24 and 25 are drawn out in an unexposed state from the holding electrode 23 through the dielectric 22 and the base member 20, and the electrical connection P1 between the end of the wire 24 and the high-voltage output terminal 31b and the electrical connection P2 between the end of the wire 25 and the high-voltage output terminal 32b are contained in the base member 20 so as to be in an unexposed state. Therefore, even if a high voltage is supplied between each of the high-voltage output terminals 31b and 32b of the booster circuit 3 and the holding electrode 23, there is no risk that discharge may occur on the wires 24 and 25 per se, at the connection P1 between the high-voltage output terminal 31b and the end of the wire 24, or at the connection P2 between the high-voltage output terminal 32b and the end of the wire 25.

Holding the workpiece plate body W with the electrostatic chuck 2 and conveying the electrostatic chuck 2 with the conveying mechanism 300 allows the deposition material 230a to be sprayed onto the workpiece plate body W when the workpiece plate body W passes directly above the deposition source 230, whereby a deposition process is performed on the workpiece plate body W.

Since the flexible contacts 43 and 44 of the electrical contact mechanism 4 continue to be in contact with the rails 41 and 42, respectively, even while the electrostatic chuck 2 is being conveyed, the low voltage of +24 volts from the external power supply 40 continues to be inputted to the high-voltage output terminals 31a and 32b of the booster circuit 3 through the rails 41 and 42 and the flexible contacts 43 and 44, respectively. As a result of this, the high voltages of +2000 volts and −2000 volts continue to be supplied to the holding electrode 23 through the wires 24 and 25, respectively.

As described above, in a case where the electrostatic chuck 2 is conveyed with the conveying mechanism 300, it is in general necessary to make the cable 41a very long in order to configure the cables 41a and 42a from the external power supply 40 to be connected to the electrostatic chuck 2.

However, since the power supply system 1-1 of the present embodiment is configured such that the rails 41 and 42 are fixed in the vacuum chamber 200 and the cables 41a and 42a from the external power supply 40 are connected to the rails 41 and 42, respectively, the cables 41a and 42a need only have such lengths as to reach the rails 41 and 42, respectively. This can make the cables 41a and 42a very short. Further, since a low voltage of +24 volts is supplied to the cables 41a and 42a, it is not necessary to seal the connection between the cable 41a and the rail 41 or the connection between the cable 42a and the rail 42.

### Second Embodiment

Next, a second embodiment of the present invention is described below.

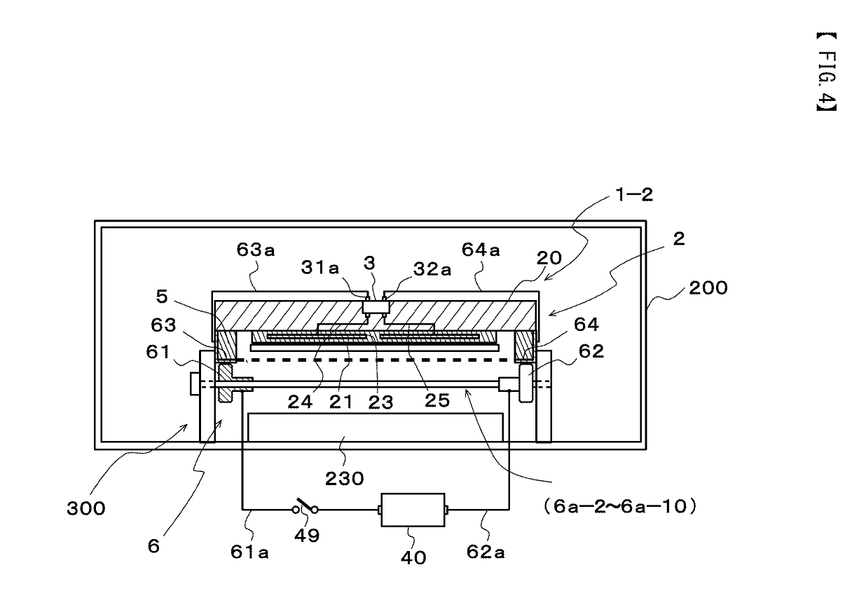

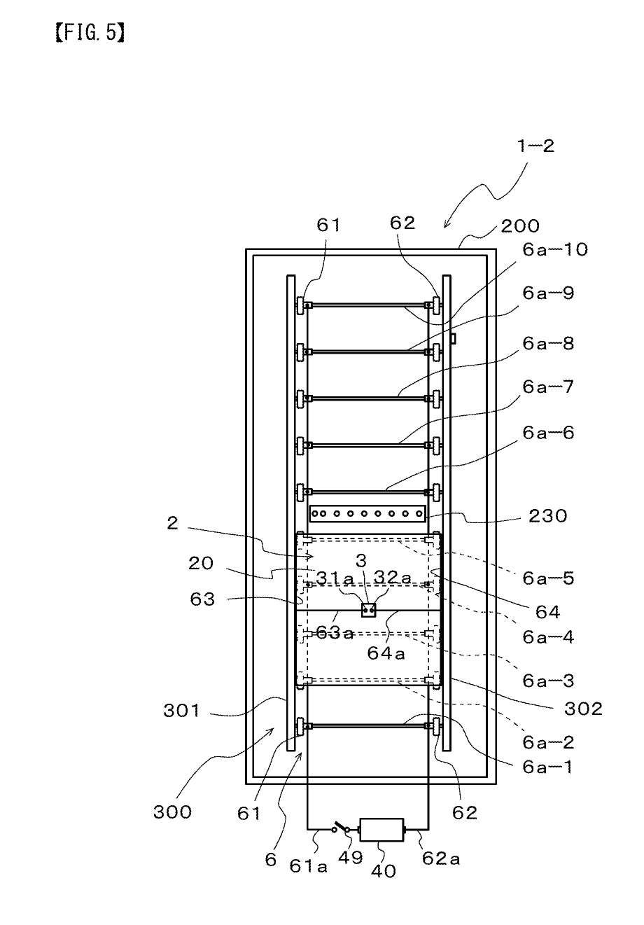

FIG. 4 is a cross-sectional view showing a power supply system according to the second embodiment of the present invention. FIG. 5 is a schematic plan view showing the power supply system.

A power supply system 1-2 of the present embodiment includes an electrical contact mechanism 6 that differs in structure from the electrical contact mechanism 4 of the power supply system 1-1 of the first embodiment.

As shown in FIG. 4, the electrical contact mechanism 6 is structured using the rollers of the conveying mechanism 300.

Specifically, the plural pairs of rollers 311 and 312 (see FIG. 1) of the conveying mechanism 300 in the first embodiment are formed by conductive rollers 61 and 62, respectively, and these rollers 61 and 62 are used as fixed electrodes of the electrical contact mechanism 6. Moreover, the rollers 61 are connected to the first terminal of the external power supply 40 through a cable 61a, and the rollers 62 are connected to the second terminal of the external power supply 40 through a cable 62a.

As shown in FIG. 5, these rollers 61 and 62 are attached to first and second ends of each rotating shaft 6a-1 (6a-2 to 6a-10), respectively, and the plurality of rotating shafts 6a-1 to 6a-10 are rotatably attached to the lanes 301 and 302.

The present embodiment is configured such that the first terminal of the external power supply 40 is connected to the rollers 61 of all of the rotating shafts 6a-1 to 6a-10 and the second terminal of the external power supply 40 is connected to the rollers 62 of all of the rotating shafts 6a-1 to 6a-10. However, for example, an alternative embodiment may be configured such that the low voltage from the external power supply 40 is supplied only to the rollers 61 and 62 of the rotating shafts 6a-1 to 6a-6 in a specified area, e.g. only to the rollers 61 and 62 of every three rotating shafts 6a-1, 6a-4, 6a-7, and 6a-10.

Meanwhile, as shown in FIG. 5, the movable electrodes of the electrical contact mechanism 6 are formed by electrode plates 63 and 64 attached to the mask 5. Moreover, these electrode plates 63 and 64 are brought into contact with the rollers 61 and 62, and are connected to the low-voltage input terminals 31a and 32a of the booster circuit 3 through cables 63a and 64a, respectively.

This configuration allows the electrode plates 63 and 64 attached to the mask 5 to move together with the electrostatic chuck 2 during conveyance of the electrostatic chuck 2. Since, at this time, the electrode plates 63 and 64 are in contact with the rollers 61 and 62 of any of the rotating shafts 6a-1 to 6a-10, respectively, the low voltage of +24 volts from the external power supply 40 is inputted to the low-voltage input terminals 31a and 32a of the booster circuit 3 through the electrical contact mechanism 6. Then, the booster circuit 3 raises the low voltage to high voltages of +2000 volts and −2000 volts that are supplied to the holding electrode 23 through the wires 24 and 25, respectively.

The other components, functions, and effects are the same as those of the first embodiment, and as such, are not described here.

### Third Embodiment

Next, a third embodiment of the present invention is described below.

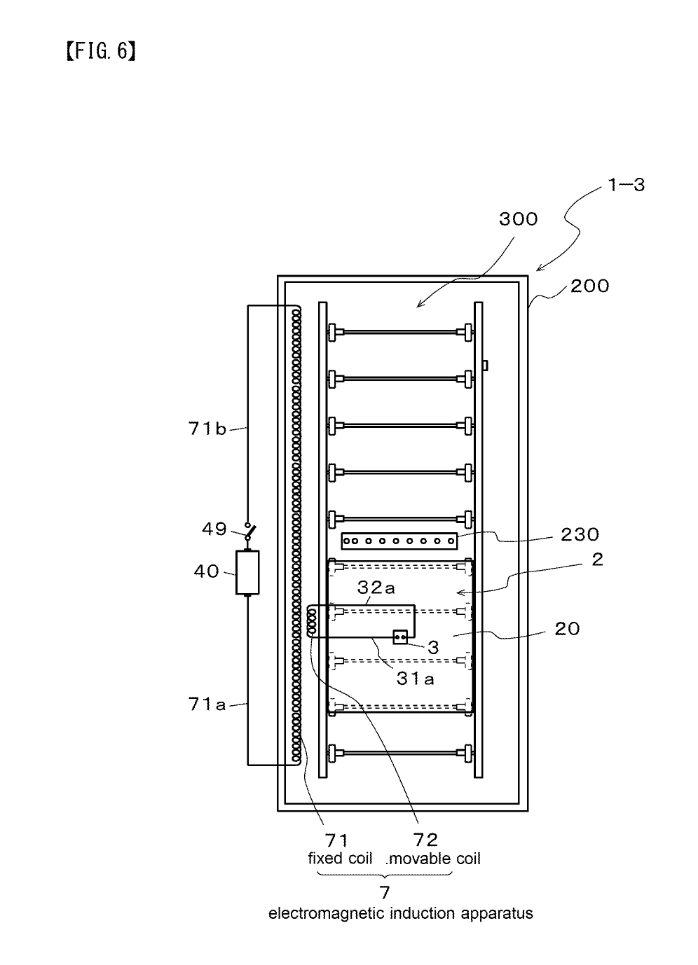

FIG. 6 is a schematic plan view showing a power supply system according to a third embodiment of the present invention.

A power supply system 1-3 of the present embodiment differs from the power supply systems of the first and second embodiments in that the power supply system 1-3 of the present embodiment includes an electromagnetic induction apparatus 7 instead of the electrical contact mechanisms of the first and second embodiments.

As shown in FIG. 6, the electromagnetic induction apparatus 7 includes a fixed coil 7 fixed in the vacuum chamber 200 and a movable coil 72 attached to the electrostatic chuck 2.

The fixed coil 71 has a length set to be substantially equal to the range of conveyance of the electrostatic chuck 2. The fixed coil 71 has first and second ends connected to the first and second terminals of the external power supply 40 through cables 71a and 71b, respectively. In the present embodiment, the external power supply 40 inputs an alternating-current low voltage to the fixed coil 71.

Meanwhile, the movable coil 72 is attached to the surface of the base member 20 of the electrostatic chuck 2 in close proximity to the fixed coil 71. The movable coil 72 has first and second ends connected to the low-voltage input terminals 31a and 32a of the booster circuit 3, respectively.

This allows the movable coil 72 to move together with the electrostatic chuck 2 without being in contact with the fixed coil 71 during conveyance of the electrostatic chuck 2. Then, when the low-voltage alternating current is inputted from the external power supply 40 to the fixed coil 71, a voltage induced by electromagnetic induction from the fixed coil 71 to the movable coil 72 is outputted from the movable coil 72 to the low-voltage input terminals 31a and 32a of the booster circuit 3. As a result of this, the booster circuit 3 raises the voltage to a high voltage that continues to be supplied to the holding electrode 23 (see FIG. 1) through the wires 24 and 25 (see FIG. 1).

The other components, functions, and effects are the same as those of the first and second embodiments, and as such, are not described here.

### Fourth Embodiment

At last, a fourth embodiment of the present invention is described below.

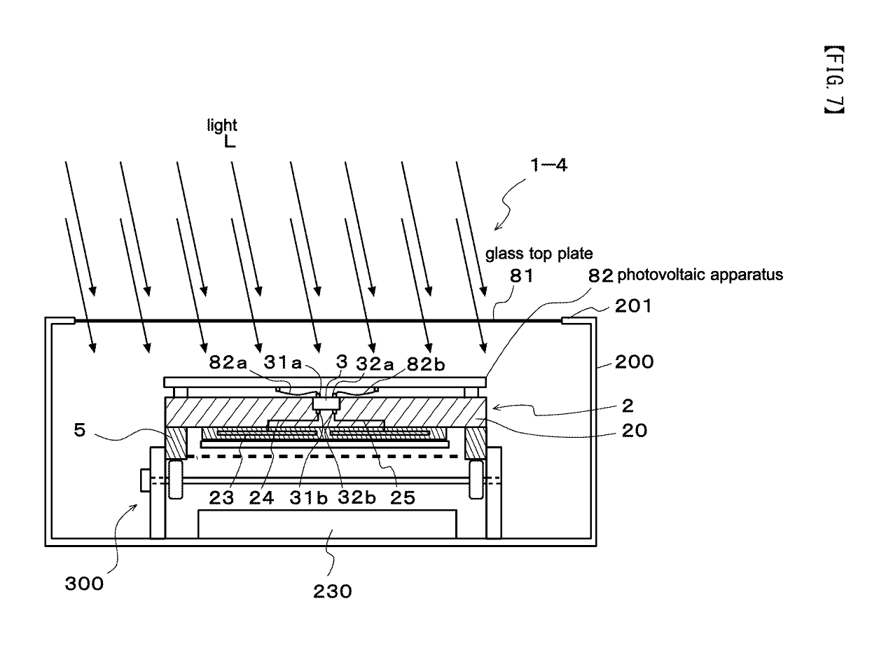

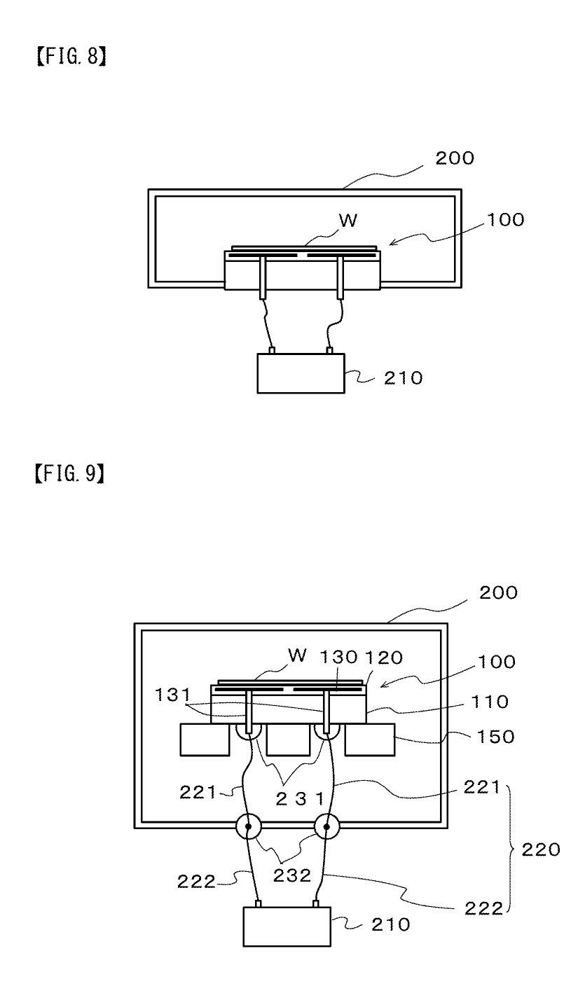

FIG. 7 is a cross-sectional view showing a power supply system according to a fourth embodiment of the present invention.

A power supply system 1-4 of the present embodiment differs from the power supply systems of the first to third embodiments in that the power supply system 1-4 of the present embodiment feeds electricity to the electrostatic chuck by means of light.

As shown in FIG. 7, the power supply system 1-4 of the present embodiment includes a glass top plate 81 and a photovoltaic apparatus 82. The glass top plate 81 serves as a transparent top plate.

The glass top plate 81 is attached to the bulk of an upper surface 201 of the vacuum chamber 200. The glass top plate 81 allows rays of light L from an external light source such as the sun or an electric lamp to be introduced into the vacuum chamber 200.

The photovoltaic apparatus 82 is a well-known apparatus configured to receive the rays of light L, convert the rays of light L into electricity of a predetermined voltage through a large number of solar cell elements (not illustrated), and output the electricity. The photovoltaic apparatus 82 is attached to the surface of the base member 20 of the electrostatic chuck 2. The photovoltaic apparatus 82 has first and second output terminals 82a and 82b electrically connected to the low-voltage input terminals 31a and 32a of the booster circuit 3, respectively. In the present embodiment, the photovoltaic apparatus 82 is set to output a low voltage of +24 volts.

According to this configuration, while the electrostatic chuck 2 is being conveyed by the conveying mechanism 300 in the vacuum chamber 200, the rays of light L introduced from the external light source into the vacuum chamber 200 through the glass top plate 81 are converted into low-voltage electricity by the photovoltaic apparatus 82 attached to the electrostatic chuck 2. Then, the low voltage thus obtained is inputted to the low-voltage input terminals 31a and 32a of the booster circuit 3, and a high voltage raised by of the booster circuit 3 is supplied to the holding electrode 23 through the high-voltage output terminals 31b and 32b and the wires 24 and 25.

That is, during conveyance of the electrostatic chuck 2, the electrostatic chuck 2 continues to be driven by the rays of light L from the external light source.

Therefore, employing the power supply system 1-4 of the present embodiment completely eliminates the need for cables, pipes, and the like extending from the external power supply 40 to the electrostatic chuck 2. Further, since a large mechanism such as the electrical contact mechanism 4 adopted in the first embodiment or the electrical contact mechanism 6 adopted in the second embodiment is not required, the power supply system can be made very simple in overall structure.

The other components, functions, and effects are the same as those of the first, second, and third embodiments, and as such, are not described here.

The present invention is not limited to the embodiments described above, but may be altered or modified in various ways within the scope of the gist of the present invention.

Since, as shown in FIG. 1 or the like, each of the power supply systems 1-1 to 1-4 is a system configured to supply electricity from the power supply to the electrostatic chuck 2 that is conveyed in the vacuum chamber 200 of the deposition apparatus, the embodiments have been described above by taking, as an example, a case where the electrostatic chuck 2 is loaded on the rollers 311 and 312 of the conveying mechanism 300 in such a state as to face downward. However, for an apparatus other than the deposition apparatus, there is a case where the electrostatic chuck 2 may be loaded on the rollers 311 and 312 of the conveying mechanism 300 in such a state as to face upward. Even in such a case, the power supply system is also of course encompassed in the scope of the present invention.

Further, the embodiments have been described by taking, as an example, a case where the booster circuit 3 is embedded in the base member 20 and only the low-voltage input terminals 31a and 32a are exposed on the outside. However, a case where the low-voltage input terminals 31a and 32a and the body of the booster circuit 3 are exposed and only the high-voltage output terminals 31b and 32b are embedded in the base member 20 is also encompassed in the scope of the present invention. In this case, however, it is preferable that the connection P1 between the high-voltage output terminal 31b and the end of the wire 24 and the connection P2 between the high-voltage output terminal 32b and the end of the wire 25 be sealed.

### REFERENCE SIGNS LIST

1-1 to 1-4 . . . power supply system,

2 . . . electrostatic chuck,

3 . . . booster circuit,

4,6 . . . electrical contact mechanism,

5 . . . mask,

6a-1 to 6a-10 . . . rotating shaft,

7 . . . electromagnetic induction apparatus,

20 . . . base member,

21 . . . electrostatic holding layer,

21a . . . surface,

22 . . . dielectric,

23 . . . holding electrode,

24, 25 . . . wire,

31a, 32a . . . low-voltage input terminal,

31b, 32b . . . high-voltage output terminal,

40 . . . external power supply,

41, 42 . . . rail,

41a, 42a, 45a, 46a, 61a to 64a, 71a, 71b . . . cable,

43, 44 . . . flexible contact,

45, 46 . . . conductive plate,

49 . . . switch,

61, 62 . . . roller,

63, 64 . . . electrode plate,

71 . . . fixed coil,

72 . . . movable coil,

81 . . . glass top plate,

82 . . . photovoltaic apparatus,

82a, 82b . . . output terminal,

200 . . . vacuum chamber,

201 . . . upper surface,

230 . . . deposition source,

230a . . . deposition material,

L . . . rays of light,

P1 to P4 . . . electrical connection,

W . . . workpiece plate body.

1. An electrostatic chuck comprising:
an electrostatic holding layer including a dielectric and a holding electrode, the dielectric having a surface serving as a holding surface on which a workpiece plate body is held, the holding electrode being placed within the dielectric;
a base member of which the electrostatic holding layer is placed on the upper surface and
a booster circuit including low-voltage input terminals through which a low voltage from an external power supply is inputted and high-voltage output terminals through which a high voltage obtained by raising the low voltage is supplied to the holding electrode,
the booster circuit being mounted in the base member,
electrical connections between ends of wires and the high-voltage output terminals being contained in the base member so as to be in an unexposed state, the wires being drawn out in an unexposed state from the holding electrode through the dielectric and the base member.

2. The electrostatic chuck according to claim 1, wherein the booster circuit inputs a voltage in the range of 5 volts to 100 volts through the low-voltage input terminals and outputs a voltage in the range of 300 volts to 10000 volts through the high-voltage output terminals.

3. A power supply system comprising:
an electrostatic chuck according to claim 1, the electrostatic chuck being conveyed by a conveying mechanism installed inside a vacuum chamber; and
an electrical contact mechanism including fixed electrodes and movable electrodes, the fixed electrodes being fixed in the vacuum chamber and connected to the external power supply, the movable electrodes being configured to move together with the electrostatic chuck and connected to the low-voltage input terminals of the booster circuit, respectively, contact between the fixed electrodes and the movable electrodes causing the low voltage from the external power supply to be inputted to the low-voltage input terminals of the booster circuit.

4. The power supply system according to claim 3, wherein:
the fixed electrodes of the electrical contact mechanism are formed by conductive rails placed parallel to a direction of conveyance in close proximity to the electrostatic chuck; and
the movable electrodes of the electrical contact mechanism are formed by conductive flexible contacts attached to the electrostatic chuck in contact with the rails, respectively.

5. The power supply system according to claim 3, wherein:
the conveying mechanism includes a plurality of conductive rollers and a pair of lanes, the plurality of conductive rollers being arranged along the direction of conveyance, the pair of lanes being set parallel to each other and configured to rotatably support these rollers; and
the fixed electrodes of the electrical contact mechanism are formed by the plurality of conductive rollers; and
the movable electrodes of the electrical contact mechanism are formed by electrode plates configured to move together with the electrostatic chuck while continuing to be in contact with the rollers.

6. A power supply system comprising:
an electrostatic chuck according to claim 1, the electrostatic chuck being conveyed by a conveying mechanism installed inside a vacuum chamber; and
an electromagnetic induction apparatus including a fixed coil and a movable coil, the fixed coil being fixed in the vacuum chamber and connected to the external power supply, the movable coil being configured to move together with the electrostatic chuck without being in contact with the fixed coil and connected to the low-voltage input terminals of the booster circuit, electromagnetic induction from the fixed coil to the movable coil causing the low voltage from the external power supply to be inputted to the low-voltage input terminals of the booster circuit.

7. The power supply system according to claim 6, wherein:
the fixed coil of the electromagnetic induction apparatus is fixed in the vacuum chamber; and
the movable coil of the electromagnetic induction apparatus is attached to the electrostatic chuck.

8. A power supply system comprising:
an electrostatic chuck according to claim 1, the electrostatic chuck being conveyed by a conveying mechanism installed inside a vacuum chamber;
a transparent top plate through which rays of light from an external light source are introduced into the vacuum chamber, the transparent top plate being provided on at least an upper surface of the vacuum chamber; and
a photovoltaic apparatus configured to convert, into low-voltage electricity, the rays of light introduced into the vacuum chamber through the transparent top plate and input the low-voltage electricity to the low-voltage input terminals of the booster circuit of the electrostatic chuck.

9. The power supply system according to claim 8, wherein the photovoltaic apparatus is attached to the electrostatic chuck.

10. A power supply system comprising:
an electrostatic chuck according to claim 2, the electrostatic chuck being conveyed by a conveying mechanism installed inside a vacuum chamber; and
an electrical contact mechanism including fixed electrodes and movable electrodes, the fixed electrodes being fixed in the vacuum chamber and connected to the external power supply, the movable electrodes being configured to move together with the electrostatic chuck and connected to the low-voltage input terminals of the booster circuit, respectively, contact between the fixed electrodes and the movable electrodes causing the low voltage from the external power supply to be inputted to the low-voltage input terminals of the booster circuit.

11. A power supply system comprising:
an electrostatic chuck according to claim 2, the electrostatic chuck being conveyed by a conveying mechanism installed inside a vacuum chamber; and
an electromagnetic induction apparatus including a fixed coil and a movable coil, the fixed coil being fixed in the vacuum chamber and connected to the external power supply, the movable coil being configured to move together with the electrostatic chuck without being in contact with the fixed coil and connected to the low-voltage input terminals of the booster circuit, electromagnetic induction from the fixed coil to the movable coil causing the low voltage from the external power supply to be inputted to the low-voltage input terminals of the booster circuit.

12. A power supply system comprising:
an electrostatic chuck according to claim 2, the electrostatic chuck being conveyed by a conveying mechanism installed inside a vacuum chamber;
a transparent top plate through which rays of light from an external light source are introduced into the vacuum chamber, the transparent top plate being provided on at least an upper surface of the vacuum chamber; and
a photovoltaic apparatus configured to convert, into low-voltage electricity, the rays of light introduced into the vacuum chamber through the transparent top plate and input the low-voltage electricity to the low-voltage input terminals of the booster circuit of the electrostatic chuck.
